(19) United States
(12) Patent Application Publication
(10) Pub. No.: US 2022/0075651 A1
(43) Pub. Date: Mar. 10, 2022

(54) HIGHLY PARALLEL PROCESSING ARCHITECTURE WITH COMPILER

(71) Applicant: Ascenium, Inc., Campbell, CA (US)

(72) Inventors: Øyvind Harboe, 4017 Stavanger (NO); Tore Bastiansen, 4022 Stavanger (NO); Peter Foley, Los Altos Hills, CA (US)

(73) Assignee: Ascenium, Inc., Campbell, CA (US)

(21) Appl. No.: 17/526,003

(22) Filed: Nov. 15, 2021

Related U.S. Application Data
(63) Continuation-in-part of application No. 17/465,949, filed on Sep. 3, 2021.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 9/48; G06F 9/50

(52) U.S. Cl. CPC G06F 9/4881; G06F 9/5016; G06F 9/5027

(57) ABSTRACT

Techniques for task processing using a highly parallel processing architecture with a compiler are disclosed. A two-dimensional array of compute elements is accessed. Each compute element within the array of compute elements is known to a compiler and is coupled to its neighboring compute elements within the array of compute elements. A set of directions is provided to the hardware, through a control word generated by the compiler, for compute element operation and memory access precedence. The set of directions enables the hardware to properly sequence compute element results. The set of directions controls data movement for the array of compute elements. A compiled task is executed on the array of compute elements, based on the set of directions. The compute element results are generated in parallel in the array, and the compute element results are ordered independently from control word arrival at each compute element.

### RELATED APPLICATIONS

This application claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array ” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

This application is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array ” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to task processing and more particularly to a highly parallel processing architecture with compiler.

### BACKGROUND

Organizations routinely execute processing jobs as part of their standard, day-to-day operations. The organizations can range in size from small, local ones to large organizations with interests that span the globe. These organizations include financial institutions, manufacturers, governments, hospitals, universities, research laboratories, social services groups, retail establishments, and many others. Irrespective of the size and the operation of an organization, the processing jobs performed by the organization process data that is relevant to their operation. In many cases, the sets of data or “datasets” are vast. These datasets can include bank account numbers and balances, trade and manufacturing secrets, identification and taxation information, medical records, records of academic grades and degrees, research data, homeless population information, sales figures, and more. Names, ages, addresses, telephone numbers, and email addresses are also commonly included. Whatever the contents of the datasets, the processing of the datasets can be computationally complex. Data fields can be blank, or data may be incorrectly entered in the wrong field; names can be misspelled; and abbreviations or shorthand notations can be inconsistently applied, to list only a few possible data input challenges. Whatever the contents of the dataset, effective processing of the data is critical.

The situation for many organizations is that the success or failure of a given organization directly depends on its ability to perform successful data processing. Further, the processing of the data is not simply performed in some random or general manner. Instead, the processing must be performed in such a way as to directly benefit the organization. Depending on the organization, a direct benefit of the data processing is competitive and financial gain. If the data processing objectives are successful in terms of meeting the requirements of an organization, then the organization thrives. If on the other hand the processing objectives are not met, then unwelcome and likely disastrous outcomes can be expected for the unsuccessful organizations. Trends contained in the data must be identified and tracked, while anomalous data is noted and followed. Identified trends and monetized anomalies can provide a competitive advantage.

The data collection techniques used to accumulate data from a wide and disparate range of individuals are many and varied. The individuals from whom the data is collected include customers, citizens, patients, students, test subjects, purchasers, and volunteers, among many others. At times however, data is collected from unwitting subjects. Techniques that are in common use for data collection include “opt-in” techniques, where an individual signs up, registers, creates an account, or otherwise agrees to participate in the data collection. Other techniques are legislative, such as a government requiring citizens to obtain a registration number and to use that number for all interactions with government agencies, law enforcement, emergency services, and others. Additional data collection techniques are more subtle or completely hidden, such as tracking purchase histories, website visits, button clicks, and menu choices. The collected data is valuable to the organizations, irrespective of the techniques used for the data collection. Rapid processing of these large datasets is critical.

### SUMMARY

Job processing, whether for running payroll, analyzing research data, or training a neural network for machine learning, is composed of many complex tasks. The tasks can include loading and storing datasets, accessing processing components and systems, and so on. The tasks themselves can be based on subtasks, where the subtasks can be used to handle loading or reading data from storage, performing computations on the data, storing or writing the data back to storage, handling inter-subtask communication such as data and control, etc. The datasets that are accessed can be vast, and can strain processing architectures that are either ill-suited to the processing tasks or inflexible in their architectures. To greatly improve task processing efficiency and throughput, two-dimensional (2D) arrays of elements can be used for the task and subtask processing. The arrays include 2D arrays of compute elements, multiplier elements, caches, queues, controllers, decompressors, ALUs, and other components. These arrays are configured and operated by providing control to the array on a cycle-by-cycle basis. The control of the 2D array is accomplished by providing directions to the hardware comprising the 2D array of compute elements, which includes related hardware units, busses, memories, and so on. The directions include a stream of control words, where the control words can include wide, variable length, microcode control words generated by a compiler. The control words are used to process the tasks. Further, the arrays can be configured in a topology which is best suited for the task processing. The topologies into which the arrays can be configured include a systolic, a vector, a cyclic, a spatial, a streaming, or a Very Long Instruction Word (VLIW) topology. The topologies can include a topology that enables machine learning functionality.

Task processing is based on a highly parallel processing architecture with a compiler. A processor-implemented method for task processing is disclosed comprising: accessing a two-dimensional (2D) array of compute elements, wherein each compute element within the array of compute elements is known to a compiler and is coupled to its neighboring compute elements within the array of compute elements; providing a set of directions to the 2D array of compute elements, through a control word generated by the compiler, for compute element operation and memory access precedence, wherein the set of directions enables the 2D array of compute elements to properly sequence compute element results; and executing a compiled task on the array of compute elements, based on the set of directions. In embodiments, the compute element results are generated in parallel in the array of compute elements. The parallel generation can enable parallel processing, single instruction multiple data (SIMD) processing, and the like. The compute element results are ordered independently from control word arrival at each compute element within the array of compute elements. Execution of a task on a compute element is dependent on both the availability of data required by the task and arrival of the control. The control word can arrive before, contemporaneously with, or subsequent to data availability. The compute element results can be ordered based on priority, precedence, and so on. In other embodiments, the set of directions controls data movement for the array of compute elements. Data movement includes loads and stores with a memory array, and includes intra-array data movement.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a highly parallel processing architecture with a compiler.

FIG. 2 is a flow diagram for providing directions.

FIG. 3 shows a system block diagram for compiler interactions.

FIG. 4A illustrates a system block diagram for a highly parallel architecture with a shallow pipeline.

FIG. 4B illustrates compute element array detail.

FIG. 5 shows a code generation pipeline.

FIG. 6 illustrates translating directions to directed acyclic graph (DAG) of operations.

FIG. 7 is a flow diagram for creating a satisfiability (SAT) model.

FIG. 8 is a system diagram for task processing using a highly parallel architecture.

### DETAILED DESCRIPTION

Techniques for data manipulation using a highly parallel processing architecture with a compiler are disclosed. The tasks that are processed can perform a variety of operations including arithmetic operations, shift operations, logical operations including Boolean operations, vector or matrix operations, and the like. The tasks can include a plurality of subtasks. The subtasks can be processed based on precedence, priority, coding order, amount of parallelization, data flow, data availability, compute element availability, communication channel availability, and so on. The data manipulations are performed on a two-dimensional array of compute elements. The compute elements can include central processing units (CPUs), graphics processing units (GPUs), application specific integrated circuits (ASICs), field programmable gate arrays (FPGAs), cores, and other processing components. The compute elements can include heterogeneous processors, processors or cores within an integrated circuit or chip, etc. The compute elements can be coupled to local storage, which can include local memory elements, register files, cache storage, etc. The cache, which can include a hierarchical cache, can be used for storing data such as intermediate results or final results, relevant portions of a control word, and the like. The control word is used to control one or more compute elements within the array of compute elements. Both compressed and decompressed control words can be used for controlling the array of elements.

The tasks, subtasks, etc., are compiled by a complier. The compiler can include a general-purpose compiler, a hardware description-based compiler, a compiler written or “tuned” for the array of compute elements, a constraint-based compiler, a satisfiability-based compiler (SAT solver), and so on. Directions are provided to the hardware, where directions are provided through one or more control words generated by the compiler. The control words can include wide, variable length, microcode control words. The length of a microcode control word can be adjusted by compressing the control word, by recognizing that a compute element is unneeded by a task so that control bits within that control word are not required for that compute element, etc. The control words can be used to route data, to set up operations to be performed by the compute elements, to idle individual compute elements or rows and/or columns of compute elements, etc. The compiled microcode control words associated with the compute elements are distributed to the compute elements. The compute elements are controlled by a control unit which operates on decompressed control words. The control words enable processing by the compute elements, and the processing task is executed. In order to accelerate the execution of tasks, the executing can include providing simultaneous execution of two or more potential compiled task outcomes. In a usage example, a task can include a control word containing a branch. Since the outcome of the branch may not be known a priori to execution of the control word containing a branch, all possible control sequences that could be executed based on the branch can be simultaneously “pre-executed”. Thus, when the control word is executed, the correct sequence of computations can be used, and the incorrect sequences of computations (e.g., the path not taken by the branch) can be ignored and/or flushed.

A highly parallel architecture with a compiler enables task processing. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA); and so on. The compute elements can include homogeneous or heterogeneous processors. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. A set of directions is provided, through a control word generated by the compiler, to the hardware. The directions can be provided on a cycle-by-cycle basis. The cycle can include a clock cycle, a data cycle, a processing cycle, a physical cycle, an architectural cycle, etc. The control is enabled by a stream of wide, variable length, microcode control words generated by the compiler. The microcode control word lengths can vary based on the type of control, compression, simplification such as identifying that a compute element is unneeded, etc. The control words, which can include compressed control words, can be decoded and provided to a control unit which controls the array of compute elements. The control word can be decompressed to a level of fine control granularity, where each compute element (whether an integer compute element, floating point compute element, address generation compute element, write buffer element, read buffer element, etc.), is individually and uniquely controlled. Each compressed control word is decompressed to allow control on a per element basis. The decoding can be dependent on whether a given compute element is needed for processing a task or subtask, whether the compute element has a specific control word associated with it or the compute element receives a repeated control word (e.g., a control word used for two or more compute elements), and the like. A compiled task is executed on the array of compute elements, based on the set of directions. The execution can be accomplished by executing a plurality of subtasks associated with the compiled task.

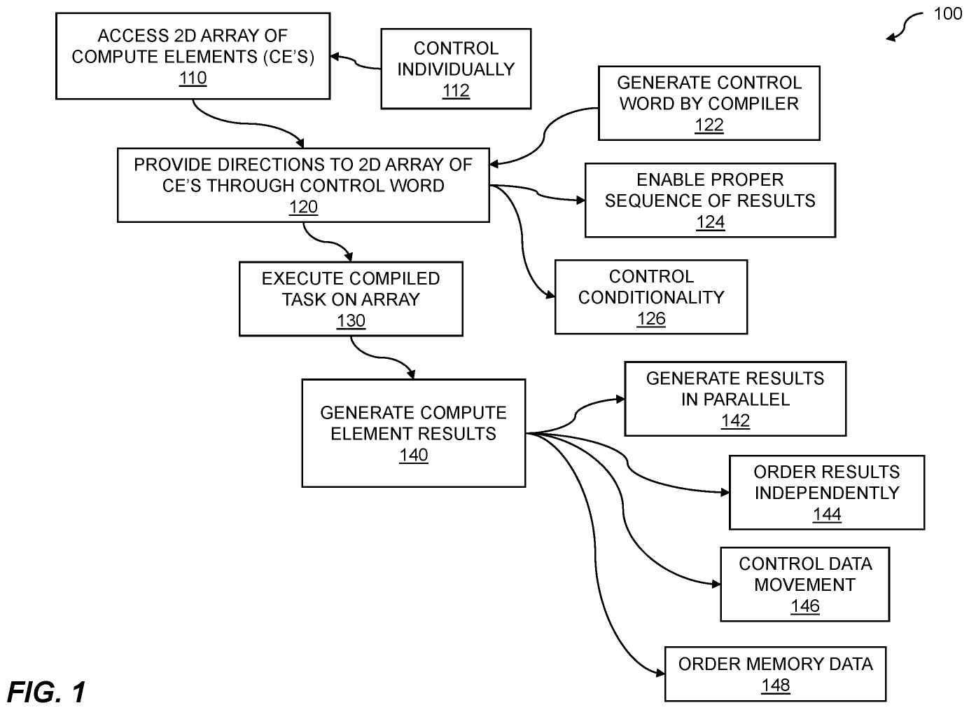

FIG. 1 is a flow diagram for a highly parallel processing architecture with a compiler. Clusters of compute elements (CEs), such as CEs assessable within a 2D array of CEs, can be configured to process a variety of tasks and subtasks associated with the tasks. The 2D array can further include other elements such as controllers, storage elements, ALUs, and so on. The tasks can accomplish a variety of processing objectives such as application processing, data manipulation, and so on. The tasks can operate on a variety of data types including integer, real, and character data types; vectors and matrices; etc. Directions are provided to the array of compute elements based on control words generated by a compiler. The control words, which can include microcode control words, enable or idle various compute elements; provide data; route results between or among CEs, caches, and storage; and the like. The directions enable compute element operation and memory access precedence. Compute element operation and memory access precedence enable the hardware to properly sequence compute element results. The directions enable execution of a compiled task on the array of compute elements.

The flow 100 includes accessing a two-dimensional (2D) array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be collocated within a single integrated circuit or chip. The compute elements can be configured in a topology, where the topology can be built into the array, programmed or configured within the array, etc. In embodiments, the array of compute elements is configured by the control word to implement one or more of a systolic, a vector, a cyclic, a spatial, a streaming, or a Very Long Instruction Word (VLIW) topology.

The array of compute elements is controlled individually 112. That is, each compute element can be programmed and controlled by the compiler to perform a unique task, unrelated at the hardware level. Thus, each element is highly exposed to the compiler in terms of its exact hardware resources. Such a fine-grained approach allows a tight coupling of the compiler and the array of compute elements, and allows the array to be controlled by a compiler-produced, wide control word, rather than having each compute element decode a stream of decoded instructions. Thus, the individual control enables a single fine-grained control word for the highly exposed array to control the array compute elements, such that each element can perform unique and different functions. In embodiments, the array comprises fine-grained, highly exposed compute elements.

The compute elements can further include a topology suited to machine learning computation. The compute elements can be coupled to other elements within the array of CEs. In embodiments, the coupling of the compute elements can enable one or more topologies. Other elements in the array of 2D compute elements to which the CEs can be coupled can include storage elements such as one or more levels of cache storage; multiplier units; address generator units for generating load (LD) and store (ST) addresses; queues; and so on. The compiler to which each compute element is known can include a general-purpose compiler such as a C, C++, or Python compiler; a hardware description language compiler such as a VHDL or Verilog compiler; a compiler written for the array of compute elements; and so on. The coupling of each CE to its neighboring CEs enables sharing of elements such as cache elements, multiplier elements, ALU elements, or control elements; communication between or among neighboring CEs; and the like.

The flow 100 includes providing a set of directions to the 2D array of compute elements through a control word 120, for compute element operation and memory access precedence. The directions can include control words for configuring elements such as compute elements within the array; loading and storing data; routing data to, from, and among compute elements; and so on. The directions can include one or more control words generated 122 by the compiler. A control word can be used to configure one or more CEs, to enable data to flow to or from the CE, to configure the CE to perform an operation, and so on. Depending on the type and size of task that is compiled to control the array of compute elements, one or more of the CEs can be controlled, while other CEs are unneeded by the particular task. A CE that is unneeded can be marked as unneeded. An unneeded CE requires no data, control word, etc., nor is a control word required by it. In embodiments, the unneeded compute element can be controlled by a single bit. In embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task. In the flow 100, the set of directions enables the hardware to properly sequence 124 compute element results. Dependencies can exist between tasks and subtasks, where the dependencies can include data dependencies. Proper sequencing can ensure that data produced by a task or subtask that is required by a second task or subtask is produced prior to the second task or subtask requiring it. In the flow 100, the set of directions controls code conditionality 126 for the array of compute elements. Code, which can include code associated with an application such as image processing, audio processing, and so on, can include conditions which can cause execution of a sequence of code to transfer to a different sequence of code. The conditionality can be based on evaluating an expression such as a Boolean or arithmetic expression. In embodiments, the conditionality can determine code jumps. The code jumps can include conditional jumps as just described, or unconditional jumps such as a jump to a halt, exit, or terminate instruction. The conditionality can be determined within the array of elements. In embodiments, the conditionality can be established by a control unit. In order to establish conditionality by the control unit, the control unit can operate on a control word provided to the control unit. In embodiments, the control unit can operate on decompressed control words. The control words can be decomposed by the array, provided to the array in a decompressed format, etc. In embodiments, the set of directions can include a spatial allocation of subtasks on one or more compute elements within the array of compute elements. In other embodiments, the set of directions can enable multiple programming loop instances circulating within the array of compute elements. The multiple programming loop instances can include multiple instances of the same programming loop, multiple programming loops, etc.

The flow 100 includes executing a compiled task on the array 130 of compute elements, based on the set of directions. Discussed previously, the tasks, which can include subtasks, can be associated with applications such as video processing applications, audio procession applications, medical or consumer data processing, and so on. The executing the task and any subtasks associated with the task can be based on a schedule, where the schedule can be based on task and subtask priority, precedence, and the like. In embodiments, the set of directions can enable simultaneous execution of two or more potential compiled task outcomes. The task outcomes result from a decision point in the code. The two or more potential compiled task outcomes comprise a computation result or a flow control. A decision point in a code can cause execution of the code to proceed in one of two or more directions. By loading the two or more directions and starting execution of them, execution time can be saved when the correct direction is finally determined. The correct direction has already begun execution, so it proceeds. The one or more incorrect directions and halted and flushed. In embodiments, the two or more potential compiled outcomes can be controlled by a same control word. The same control word can control loading data, storing data, etc. The control word can be executed based on an architectural cycle, where an architectural cycle can enable an operation across the array of elements such as compute elements. In embodiments, the same control word can be executed on a given cycle across the array of compute elements. In other embodiments, the two or more potential compiled outcomes are executed on spatially separate compute elements within the array of compute elements. The execution on spatially separate compute elements can better manage array resources, can reduce data contention or control conflicts, and so on. The executing can further enable the array of compute elements to implement a variety of functionalities such as image, audio, or other data processing functionalities, machine learning functionality, etc.

In the flow 100, the compute element results are generated 140. The compute element results can be based on processing data, where the data can be provided using an input to the array of compute elements, by loading data from storage, by receiving data from another compute element, and so on. In the flow 100, the compute element results are generated in parallel 142 in the array of compute elements. The generated results by a compute element can be based on both the compute element receiving a control word and the availability of data to be processed by the compute element. The compute elements that have received both a control word and the required input data can be executed. Parallel execution can occur when unconflicted array resources can be provided to the compute elements. An unconflicted resource can include a resource required by one compute element, a resource that can be shared by two or more compute elements without a conflict such as data contention, and the like. In the flow 100, the compute element results are ordered independently 144 from control word arrival at each compute element within the array of compute elements. A control word can be provided to a compute element at a time based on a processing schedule. The independent ordering of the compute element results is dependent on data availability, on compute resource availability, and so on. The control word can arrive before, contemporaneously with, or subsequent to the data availability and the compute resource availability. That is, while arrival of the control word is necessary, it alone is not sufficient for the compute element to execute a task, subtask, etc. In the flow 100, the set of directions controls data movement 146 for the array of compute elements. The data movement can include providing data to a compute element, handing data from a compute element, routing data between or among processing elements, etc. In embodiments, the data movement can include loads and stores with a memory array. The memory array can simultaneously support a single write operation and one or more read operations. In other embodiments, the data movement can include inter-array data movement. The inter-array data movement can be accomplished using a variety of techniques such as sharing registers, register files, caches, storage elements, and so on. In the flow 100, the memory access precedence enables ordering of memory data 148. The ordering of memory data can include loading or storing data to memory in a certain order, loading or storing data to specific areas of memory, and the like. In embodiments, the ordering of memory data can enable compute element result sequencing.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

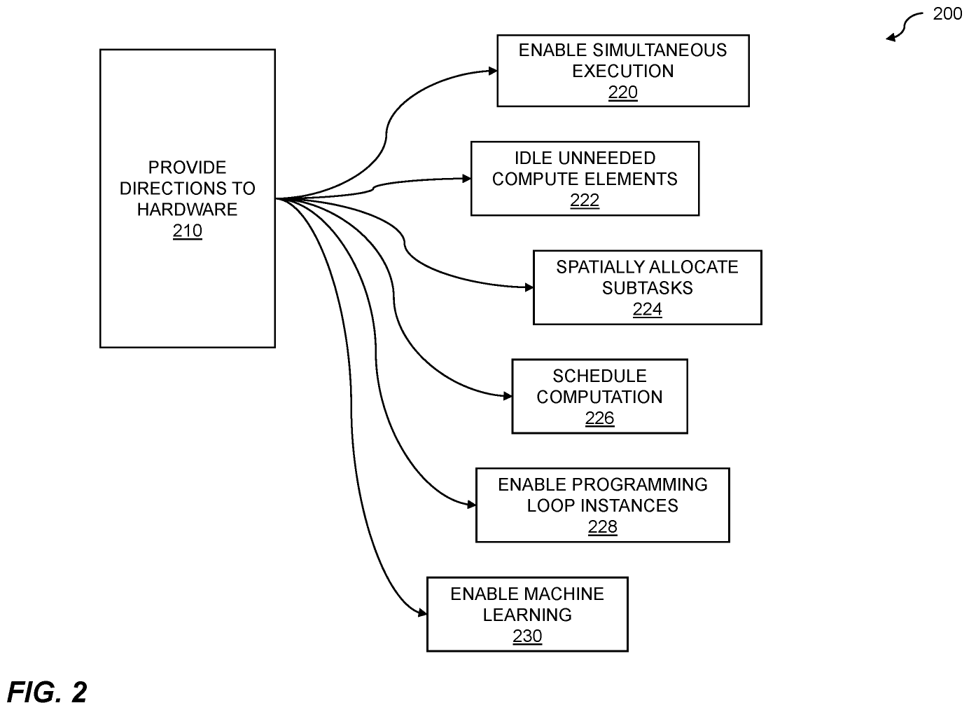

FIG. 2 is a flow diagram for providing directions. Discussed throughout, tasks can be processed on an array of compute elements. A task can include general operations such as arithmetic, vector, array, or matrix operations; Boolean operations; operations based on applications such as neural network or deep learning operations; and so on. In order for the tasks to be processed correctly, directions are provided to the array of compute elements that configure the array to execute tasks. The directions can be provided to the array of compute elements by a compiler. The providing directions that control placement, scheduling, data transfers and so on can maximize task processing throughput. This ensures that a task that generates data for a second task is processed prior to processing of the second task, and so on. The provided directions enable a highly parallel processing architecture with a compiler. A two-dimensional (2D) array of compute elements is accessed, wherein each compute element within the array of compute elements is known to a compiler and is coupled to its neighboring compute elements within the array of compute elements. A set of directions is provided to the hardware, through a control word generated by the compiler, for compute element operation and memory access precedence, wherein the set of directions enables the hardware to properly sequence compute element results. A compiled task is executed on the array of compute elements, based on the set of directions.

The flow 200 includes providing a set of directions to the hardware 210, through a control word generated by the compiler. The control word is provided for compute element operation and memory access precedence. The set of directions enables the hardware to properly sequence compute element results. The sequencing of compute element results can be based on element placement, results routing, computation wavefront propagation, and so on, within the array of compute elements. The set of directions can control data movement for the array of compute elements. The data movement can include load operations; store operations; transfers of data to, from, and among elements within the array; and the like. In the flow 200, the set of directions can enable simultaneous execution 220 of two or more potential compiled task outcomes. Recall that a task, a subtask, and so on, can include a condition. A condition can be based on an exception, evaluation of a Boolean expression or arithmetic expression, and so on. A condition can transfer instruction execution from one sequence of instructions to another sequence of instructions. Since which sequence will be the correct one is not known prior to evaluating the condition, then the possible outcomes can be fetched, and execution of the outcomes can be started. Once the correct outcome is determined, the correct sequence of instructions can proceed, and the incorrect sequence can be halted and flushed. In embodiments, the two or more potential compiled task outcomes can include a computation result or a flow control. Control of the potential compiled outcomes can be controlled by control words. In embodiments, the two or more potential compiled outcomes can be controlled by a same control word.

In the flow 200, the set of directions can idle an unneeded compute element 222 within a row of compute elements within the array of compute elements. A given set of tasks and subtasks can be allocated to compute elements within the array of compute elements. For the given set, the allocations of the tasks and subtasks may not require that all compute elements be allocated. Unallocated compute elements, as well as control elements, arithmetic logic units (ALUs), storage elements, and so on, can be idled when not needed. Idling unallocated elements can simply control, ease data handling congestion, reduce power consumption and heat dissipation, etc. In embodiments, the idling can be controlled by a single bit in the control word. In the flow 200, the set of directions can include a spatially allocating subtasks 224 on one or more compute elements within the array of compute elements. The spatial allocation can include allocating adjacent or nearby compute elements to two or more subtasks that have a level of intercommunication, while allocating distant compute elements to subtasks that do not communicate.

In the flow 200, the set of directions can include scheduling computation 226 in the array of compute elements. Scheduling tasks and subtasks is based on dependencies. The dependencies can include task priorities, precedence, data interactions, and so on. In a usage example, subtask 1 and subtask 2 can execute in parallel and can produce an output data set each. The output datasets from the subtasks serve as input datasets to subtask 3. Although subtask 1 and subtask 2 do not necessarily have to be executed in parallel, both output datasets must be generated prior to execution of subtask 3. The precedence of subtask 1 and subtask 2 executing ahead of subtask 3 is handled by the scheduling. In the flow 200, the set of directions can enable multiple programming loop instances 228 circulating within the array of compute elements. The multiple programming loop instances can include multiple instances of the same programming loop. The multiple instances of the same programming loop can enhance parallel processing. The multiple instances can enable the same set of instructions to process multiple datasets based on a single instruction multiple data (SIMD) technique. The multiple instances can include different programming loops, where the different programming loops can take advantage of compute elements that would otherwise remain idle. In the flow 200, the set of directions can enable machine learning functionality 230. The machine learning functionality can be based on support vector machine (SVM) techniques, deep learning (DL) techniques, and so on. In embodiments, the machine learning functionality can include neural network implementation. The neural network implementation can include a convolutional neural network, a recurrent neural network, and the like.

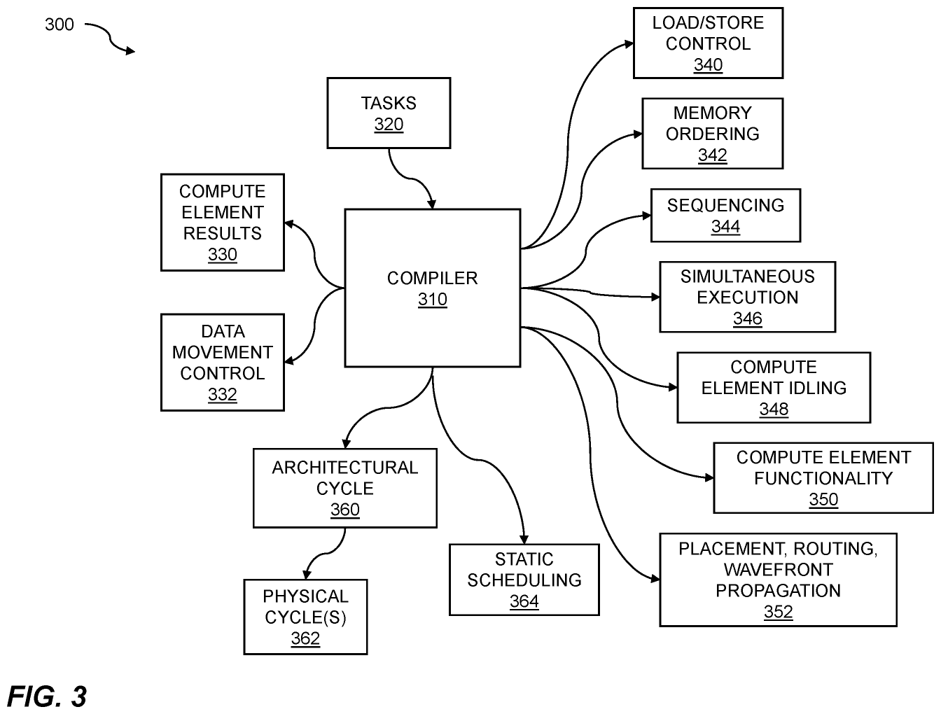

FIG. 3 shows a system block diagram for compiler interactions. Discussed throughout, compute elements within an array are known to a computer which can compile tasks and subtasks for execution on the array. The compiled tasks and subtasks are executed to accomplish task processing. A variety of interactions, such as placement of tasks, routing of data, and so on, can be associated with the compiler. The interactions enable a highly parallel processing architecture with a compiler. A two-dimensional (2D) array of compute elements is accessed. Each compute element within the array of compute elements is known to a compiler and is coupled to its neighboring compute elements within the array of compute elements. A set of directions is provided to the hardware, through a control word generated by the compiler, for compute element operation and memory access precedence. The set of directions enables the hardware to properly sequence compute element results. A compiled task is executed on the array of compute elements, based on the set of directions.

The system block diagram 300 includes a compiler 310. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the compute elements and other elements within the array. The compiler can be used to compile tasks 320. The tasks can include a plurality of tasks associated with a processing task. The tasks can further include a plurality of subtasks. The tasks can be based on an application such as a video processing or audio processing application. In embodiments, the tasks can be associated with machine learning functionality. The compiler can generate directions for handling compute element results 330. The compute element results can include arithmetic, vector, array, and matrix operations; Boolean results; and so on. In embodiments, the compute element results are generated in parallel in the array of compute elements. Parallel results can be generated by compute elements when the compute elements can share input data, use independent data, and the like. The compiler can generate a set of directions that controls data movement 332 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler can provide directions for task and subtasks handling, input data handling, intermediate and result data handling, and so on. The compiler can further generate directions for configuring the compute elements, storage elements, control units, ALUs, and so on, associated with the array. Previously discussed, the compiler generates directions for data handling to support the task handling. In the system block diagram, the data movement can include loads and stores 340 with a memory array. The loads and stores can include handling various data types such as integer, real or float, double-precision, character, and other data types. The loads and stores can load and store data into local storage such as registers, register files, caches, and the like. The caches can include one or more levels of cache such as level 1 (L1) cache, level 2 (L2) cache, level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 342. Memory data can be ordered based on task data requirements, subtask data requirements, and so on. The memory data ordering can enable parallel execution of tasks and subtasks.

In the system block diagram 300, the ordering of memory data can enable compute element result sequencing 344. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 346 of two or more potential compiled task outcomes based on the set of directions. The code that is compiled by the compiler can include branch points, where the branch points can include computations or flow control. Flow control transfers instruction execution to a different sequence of instructions. Since the result of a branch decision, for example, is not known a priori, then the sequences of instructions associated with the two or more potential task outcomes can be fetched, and each sequence of instructions can begin execution. When the correct result of the branch is determined, then the sequence of instructions associated with the correct branch result continues execution, while the branches not taken are halted and the associated instructions flushed. In embodiments, the two or more potential compiled outcomes can be executed on spatially separate compute elements within the array of compute elements.

The system block diagram includes compute element idling 348. In embodiments, the set of directions from the compiler can idle an unneeded compute element within a row of compute elements within the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 350. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wavefront propagation 352 within the array of compute elements. The compiler can generate directions or instructions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wavefront propagation. Computation wavefront propagation can describe and control how execution of tasks and subtasks proceeds through the array of compute elements.

In the system block diagram, the compiler can control architectural cycles 360. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met. That is, the array of compute elements does not have to wait for either dependent data to load or for a full memory queue to clear.

In the system block diagram, the architectural cycle can include one or more physical cycles 362. A physical cycle can refer to one or more cycles at the element level required to implement a load, an execute, a write, and so on. In embodiments, the set of directions can control the array of compute elements on a physical cycle-by-cycle basis. The physical cycles can be based on a clock such as a local, module, or system clock, or other timing or synchronizing techniques. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. The operand size is used to determine how many load operations may be required to obtain data. Various operand sizes can be used. In embodiments, the operand size can include bytes, half-words, words, and double-words. In the system block diagram, the compiler can use static scheduling 364 of the array of compute elements to avoid dynamic, hardware-based scheduling. Thus, in embodiments, the array of compute elements is statically scheduled by the compiler.

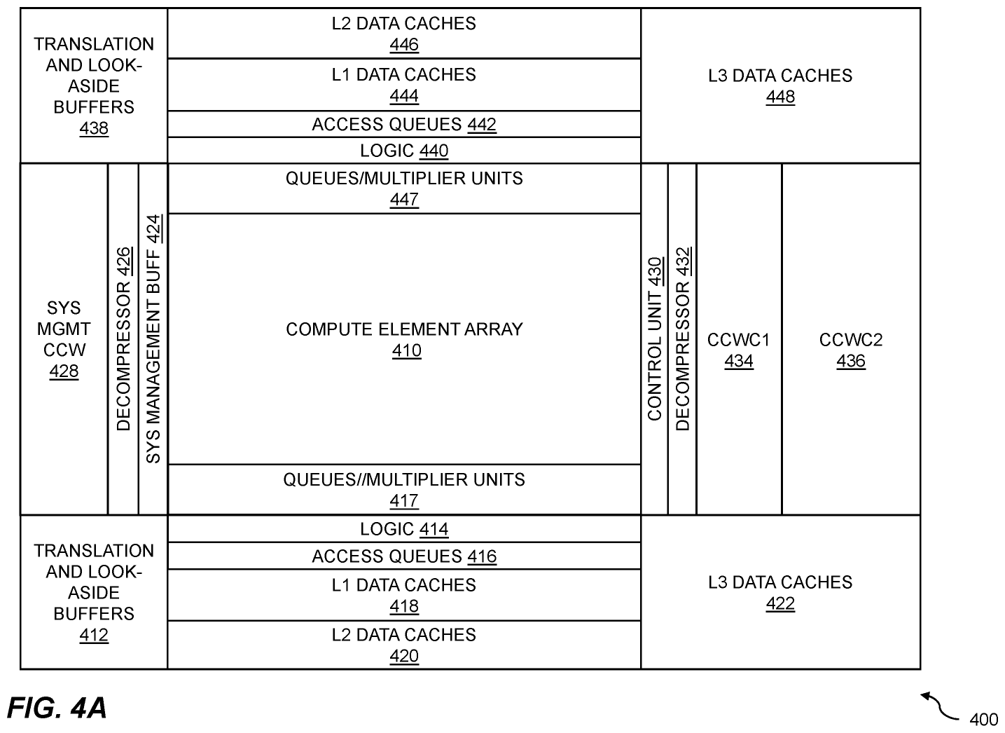

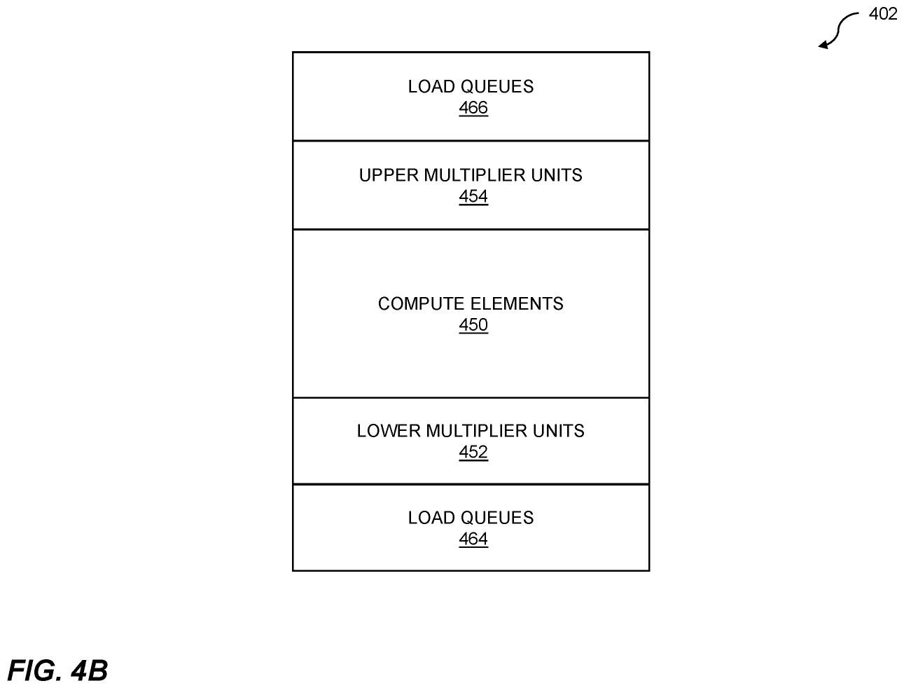

FIG. 4A illustrates a system block diagram for a highly parallel architecture with a shallow pipeline. The highly parallel architecture can comprise components including compute elements, processing elements, buffers, one or more levels of cache storage, system management, arithmetic logic units, multipliers, and so on. The various components can be used to accomplish task processing, where the task processing is associated with program execution, job processing, etc. The task processing is enabled using a parallel processing architecture with distributed register files. A two-dimensional (2D) array of compute elements is accessed, wherein each compute element within the array of compute elements is known to a compiler and is coupled to its neighboring compute elements within the array of compute elements. Directions are provided to the array of compute elements based on control words generated by a compiler. The control words, which can include microcode control words, enable or idle various compute elements; provide data; route results between or among CEs, caches, and storage; and the like. The directions enable compute element operation and memory access precedence. Compute element operation and memory access precedence enable the hardware to properly sequence compute element results. The directions enable execution of a compiled task on the array of compute elements.

A system block diagram 400 for a highly parallel architecture with a shallow pipeline is shown. The system block diagram can include a compute element array 410. The compute element array 410 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 400 can include translation and look-aside buffers such as translation and look-aside buffers 412 and 438. The translation and look-aside buffers can comprise memory caches, where the memory caches can be used to reduce storage access times. The system block diagram can include logic for load and access order and selection. The logic for load and access order and selection can include logic 414 and logic 440. Logic 414 and 440 can accomplish load and access order and selection for the lower data block (416, 418, and 420) and the upper data block (442, 444, and 446), respectively. This layout technique can double access bandwidth, reduce interconnect complexity, and so on. Logic 440 can be coupled to compute element array 410 through the queues and multiplier units 447 component. In the same way, logic 414 can be coupled to compute element array 410 through the queues and multiplier units 417 component.

The system block diagram can include access queues. The access queues can include access queues 416 and 442. The access queues can be used to queue requests to access caches, storage, and so on, for storing data and loading data. The system block diagram can include level 1 (L1) data caches such as L1 caches 418 and 444. The L1 caches can be used to store blocks of data such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 420 and 446. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 422 and 448. The L3 caches can be larger than the L1 and L2 caches and can include slower storage. Accessing data from L3 caches is still faster than accessing main storage. In embodiments, the L1, L2, and L3 caches can include 4-way set associative caches.

The block diagram 400 can include a system management buffer 424. The system management buffer can be used to store system management codes or control words that can be used to control the array 410 of compute elements. The system management buffer can be employed for holding opcodes, codes, routines, functions, etc. which can be used for exception or error handling, management of the parallel architecture for processing tasks, and so on. The system management buffer can be coupled to a decompressor 426. The decompressor can be used to decompress system management compressed control words (CCWs) from system management compressed control word buffer 428 and can store the decompressed system management control words in the system management buffer 424. The compressed system management control words can require less storage than the uncompressed control words. The system management CCW component 428 can also include a spill buffer. The spill buffer can comprise a large static random-access memory (SRAM) which can be used to support multiple nested levels of exceptions.

The compute elements within the array of compute elements can be controlled by a control unit such as control unit 430. While the compiler, through the control word, controls the individual elements, the control unit can pause the array to ensure that new control words are not driven into the array. The control unit can receive a decompressed control word from a decompressor 432. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 434. CCWC1 can include a cache such as an L1 cache that includes one or more compressed control words. CCWC1 can be coupled to a further compressed control word store such as compressed control word cache 2 (CCWC2) 436. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 432 can be coupled between CCWC1 434 (now DCWC1) and CCWC2 436.

FIG. 4B shows compute element array detail 402. A compute element array can be coupled to components which enable the compute elements to process one or more tasks, subtasks, and so on. The components can access and provide data, perform specific high-speed operations, and the like. The compute element array and its associated components enable a parallel processing architecture with background loads. The compute element array 450 can perform a variety of processing tasks, where the processing tasks can include operations such as arithmetic, vector, matrix, or tensor operations; audio and video processing operations; neural network operations; etc. The compute elements can be coupled to multiplier units such as lower multiplier units 452 and upper multiplier units 454. The multiplier units can be used to perform high-speed multiplications associated with general processing tasks, multiplications associated with neural networks such as deep learning networks, multiplications associated with vector operations, and the like. The compute elements can be coupled to load queues such as load queues 464 and load queues 466. The load queues can be coupled to the L1 data caches as discussed previously. The load queues can be used to load storage access requests from the compute elements. The load queues can track expected load latencies and can notify a control unit if a load latency exceeds a threshold. Notification of the control unit can be used to signal that a load may not arrive within an expected timeframe. The load queues can further be used to pause the array of compute elements. The load queues can send a pause request to the control unit that will pause the entire array, while individual elements can be idled under control of the control word. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data and control word) can be performed. The memory systems can be free running and can continue to operate while the array is paused. Because multi-cycle latency can occur due to control signal transport, which results in additional “dead time”, it can be beneficial to allow the memory system to “reach into” the array and deliver load data to appropriate scratchpad memories while the array is paused. This mechanism can operate such that the array state is known, as far as the compiler is concerned. When array operation resumes after a pause, new load data will have arrived at a scratchpad, as required for the compiler to maintain the statically scheduled model.

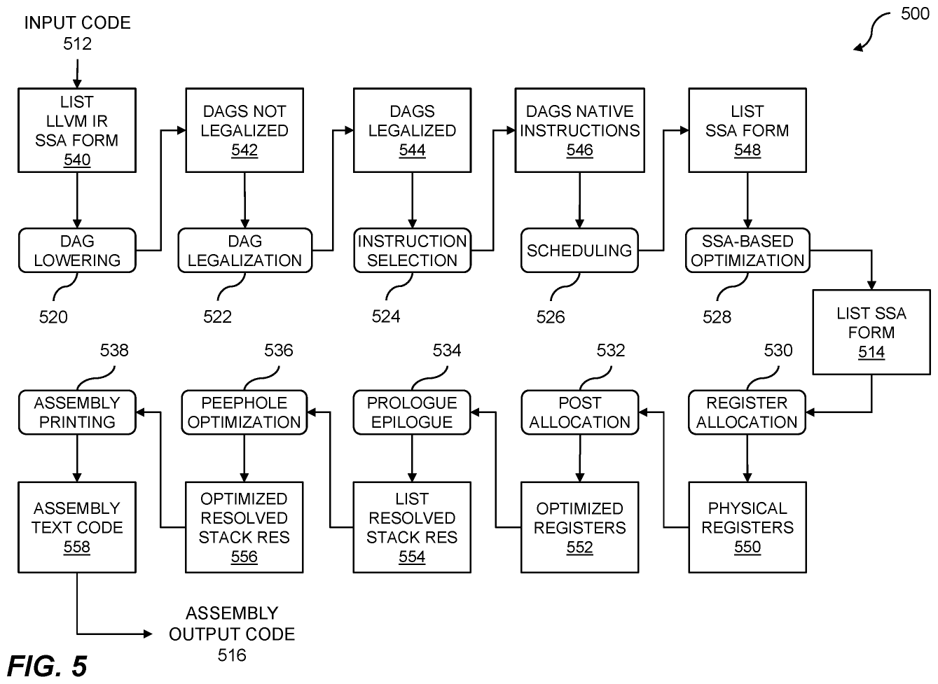

FIG. 5 shows a code generation pipeline. Directions that are provided to hardware can include code for task processing. The code can include code written in a high-level language such as C, C++, Python, etc.; in a low-level language such as assembly language or microcode; and so on. The code generation pipeline can comprise a compiler. The code generation pipeline can be used to convert an intermediate code or intermediate representation such as low-level virtual machine (LLVM) intermediate representation (IR) to a target machine code. The target machine code can include machine code that can be executed by one or more compute elements of the array of compute elements. The code generation pipeline enables a highly parallel processing architecture with a compiler. An example code generation pipeline 500 is shown. The code generation pipeline can perform one or more operations to convert code such as the LLVM IR code to a target machine language appropriate for execution on one or more compute elements within the array of compute elements. The pipeline can receive input code 512 in list form 540. The pipeline can include a directed acyclic graph (DAG) lowering component 520. The DAG lowering component can reduce the order of the DAG and can output a non-legalized or unconfirmed DAG 542. The non-legalized DAG can be legalized or confirmed using a DAG legalization component 522, which can output a legalized DAG 544. The legalized DAG can be provided to an instruction selection component 524. The instruction selection component can include generated native instructions 546 where the native instructions can be appropriate for one or more compute elements of the array of compute elements. The native instructions, which can represent processing tasks and subtasks, can be scheduled using a scheduling component 526. The scheduling component can be used to generate code in a static single assignment (SSA) form 548 of an intermediate representation (IR). The SSA form can include a single assignment of each variable, where the assignment occurs before the variable is referenced or used within the code. The code in SSA format can be optimized using an optimizer component 528. The optimizer can generate optimized code in SSA form 514.

The optimized code in SSA form can be processed using a register allocation component 530. The register allocation component can generate a list of physical registers 550, where the physical registers can include registers or other storage within the array of compute elements. The code generation pipeline can include a post allocation component 532. The post allocation component can be used to resolve register allocation conflicts, to optimize register allocations, and the like. The post allocation component can include a list of optimized physical registers 552. The pipeline can include a prologue and an epilogue component 534 which can add code associated with a prologue and code associated with an epilogue. The prologue can include code that can prepare the registers, a stack, and so on, for use. The epilogue can include code to reverse the operations performed by the prologue when the code between the prologue and the epilogue has been executed. The prologue and epilogue component can generate a list of resolved stack reservations 554. The pipeline can include a peephole optimization component 536. The peephole optimization component can be used to optimize a small sequence of code or a “peephole” to improve performance of the small sequence of code. The output of the peephole optimizer component can include an optimized list of resolved stack reservations 556. The pipeline can include an assembly printing component 538. The assembly printing component can generate assembly language text of the assembly code 558 that can be executed by the compute elements within the array. The output of the standard code generation pipeline can include output assembly code 516.

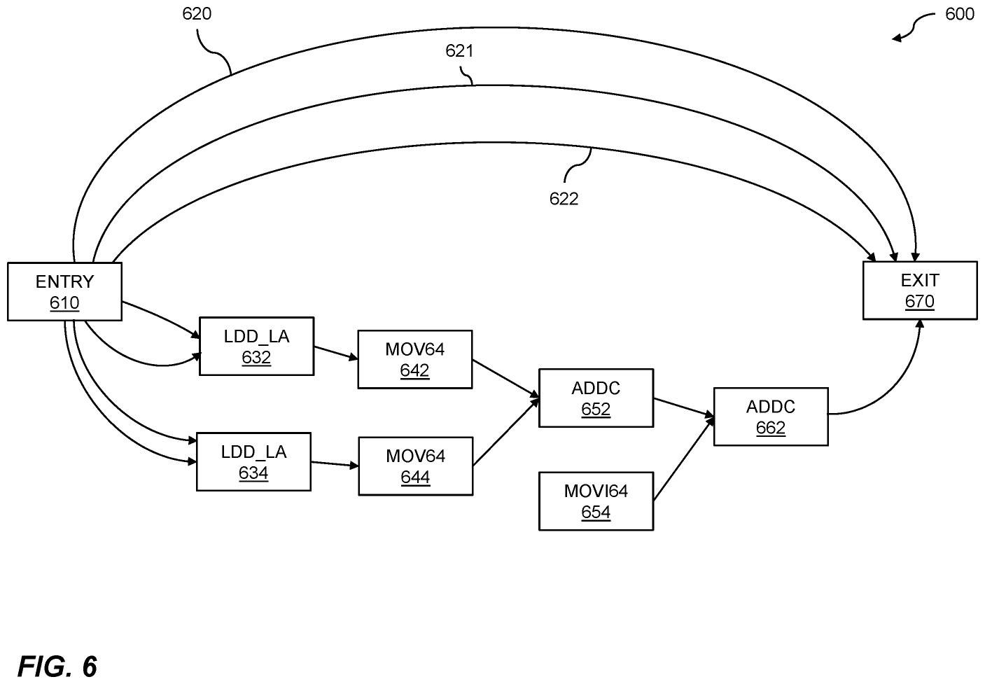

FIG. 6 illustrates translating directions to a directed acyclic graph (DAG) of operations. The processing of tasks and subtasks on an array of compute elements can be modeled using a directed acyclic graph. The DAG shows dependencies between and among the tasks and subtasks. The dependencies can include task and subtask precedence, priorities, and the like. The dependencies can also indicate an order of execution and the flow of data to, from, and among the tasks and subtasks. Translating instructions to a DAG enables a highly parallel processing architecture with a compiler. A two-dimensional (2D) array of compute elements is accessed. Each compute element within the array is known to a compiler and is coupled to its neighboring compute elements. A set of directions is provided to the hardware, through a control word generated by the compiler, for compute element operation and memory access precedence. The set of directions enables the hardware to properly sequence compute element results. A compiled task is executed on the array of compute elements.

A set of directions, which can include code, instructions, microcode, and so on, can be translated to DAG operations 600. The instructions can include low level virtual machine (LLVM) instructions. Given code, such as code that describes directions discussed previously and throughout, a DAG can be generated. The DAG can include information about placement of tasks and subtasks, but does not necessarily include information about the scheduling of the tasks and subtasks and the routing of data to, from, and among the tasks. The graph includes an entry 610 or input, where the entry can represent an input port, a register, an address in storage, etc. The entry can be coupled to an output or exit 670. The exit point of the DAG can be reached by completing tasks and subtasks of the DAG. In the event of an exception such as an error, missing data, a storage access conflict, etc., then the DAG can exit with an error. The entry and the exit of the DAG can be coupled by one or more arcs 620, 621, and 622, where each arc 620, 621, and 622 can provide data directly to output 670 without including one or more processing steps. Other arcs between entry 610 and exit 670 can include processing steps that must be completed before data is provided to exit 670. The processing steps can be associated with the tasks, subtasks, and so on. An example sequence of processing steps, based on the directions, is shown. The sequence of processing steps can include a load double (LDD) instruction 632 with two inputs from entry 610. The LDD instruction can load a double precision (e.g., 64-bit) value. The sequence can include a move 64-bit (MOV64) instruction 642. The MOV64 instruction can move a double precision value between a register and storage, between storage and a register, between registers, etc. The sequence can include an add with carry (ADDC) instruction 652. The ADDC instruction stores the sum and the carry value. The sequence can include another add with carry (ADDC) instruction 662, one of whose inputs comes from ADDC 652, and the other of whose inputs is a constant provided by move 64-bit integer (MOVI64) 654. The sequence of processing steps can include an additional load double (LDD) instruction 634 with two inputs from entry 610. The additional LDD instruction can load a double precision (e.g., 64-bit) value. The sequence can include an additional move 64-bit (MOV64) instruction 644. The additional MOV64 instruction can move a double precision value between a register and storage, between storage and a register, between registers, etc. The output of MOV64 644 can provide a second input into add with carry (ADDC) instruction 652. On completion of the last instruction in the sequence of instructions, flow within the DAG proceeds to the exit of the graph.

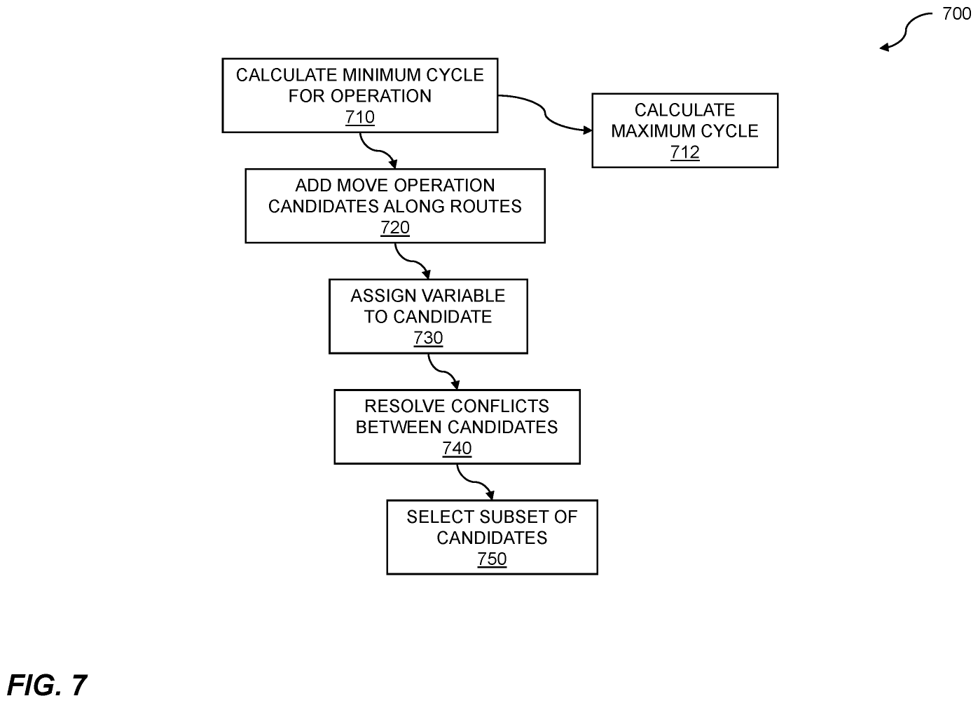

FIG. 7 is a flow diagram for creating a satisfiability (SAT) model. Task processing, which comprises processing tasks, subtasks, and so on, includes performing one or more operations associated with the tasks. The operations can include arithmetic operations; Boolean operations; vector, array, or matrix operations; tensor operations; and so on. In order for tasks, subtasks and so on to be processed correctly, the directions that are provided to hardware such as the compute elements within the 2D array must indicate when the operations are to be performed and how to route data to and from the operations. A satisfiability or SAT model can be created for ordering tasks, operations, etc., and for providing data to and from the compute elements. Creating a satisfiability model enables a highly parallel processing architecture with a compiler. Each operation associated with a task, subtask, and so on, can be assigned a clock cycle, where the clock cycle can be relative to a clock cycle associated with the start of a block of instructions. One or more move (MV) operations can be inserted between an output of an operation and inputs to one or more further operations.

The flow 700 includes calculating a minimum cycle 710 for an operation. The minimum cycle can include the earliest cycle during which an operation can be performed. The cycle can include a physical cycle such as a local, module, subsystem, or system clock; an architectural clock; and so on. The minimum cycle can be determined by traversing a directed acyclic graph (DAG) in topological order. The traversing can be used to calculate a distance between an output of the DAG and an input. Data can flow from, to, or between compute elements without conflicting with other data. In embodiments, the set of directions can control the array of compute elements on a physical cycle-by-cycle basis. A physical cycle can enable an operation, transfer data, and so on. In embodiments, the cycle-by-cycle basis can be enabled by a stream of wide, variable length, microcode control words generated by the compiler. The microcode control words can enable elements such as compute elements, arithmetic logic units (ALUs), memories or other storage, etc. In other embodiments, the physical cycle-by-cycle basis can include an architectural cycle. A physical cycle can differ from an architectural cycle in that a physical cycle can orchestrate a given operation or set of operations on one or more compute element or other elements. An architectural cycle can include a cycle of an architecture, where the architecture can include compute elements, ALUs, memories, and so on. An architectural cycle can include one or more physical cycles. The flow 700 includes calculating a maximum cycle 712. The maximum cycle can include the latest cycle during which an operation can be performed. If the minimum cycle equals the maximum cycle for a given operation, then that operation is placed on a critical path of the DAG.

The flow 700 includes adding move operation candidates 720 along different routes from an output to an input. The move operation candidates can include possible placements of operations or “candidates” to compute elements and other elements within the array. The candidates can be based on directions generated by the compiler. In embodiments, the set of directions can include a spatial allocation of subtasks on one or more compute elements within the array of compute elements. The spatial allocation can ensure that operations do not interfere with one another with respect to resource allocation, data transfers, etc. A subset of the operation candidates can be chosen such that the resulting program, that is, the code generated by the complier, is correct. The correct code successfully accomplishes the processing of the tasks. The flow 700 includes assigning a Boolean variable to each candidate 730. If the Boolean variable is true, then the candidate is included. If the Boolean variable is false, then the candidate is not included. By imposing logical constraints between or among the Boolean variables, a correct program can be achieved. The logical constraints can include performing an operation only once such that all inputs can be satisfied, one or more ALUs have a unique configuration, the candidates cannot move different values into the same register, and the candidates cannot set control word bits to conflicting values.

The flow 700 includes resolving conflicts 740 between candidates. Conflicts can occur between candidates, where the conflicts can include violations of one or more constraints listed above, resource contention, data conflicts, and so on. Simple conflicts between candidates can be formulated using conjunctive normal form (CNF) clauses. The constraints based on the CNF clauses can be evaluated using a solver such as an operations research (OR) solver. The flow 700 includes selecting a subset 750 of candidates. Discussed above, the subset of candidates can be selected such that the resulting “program”, that is the sequencing of operations, subtasks, tasks, etc., is correct. In the sense of a program, “correctness” refers to the ability of the program to meet a specification. A program is correct if for each input, the expected output is produced. The program can be compiled by the compiler to generate a set of directions for the array. Not all elements of the array may be required for implementing the set of directions. In embodiments, the set of directions can idle an unneeded compute element within a row of compute elements within the array of compute elements.

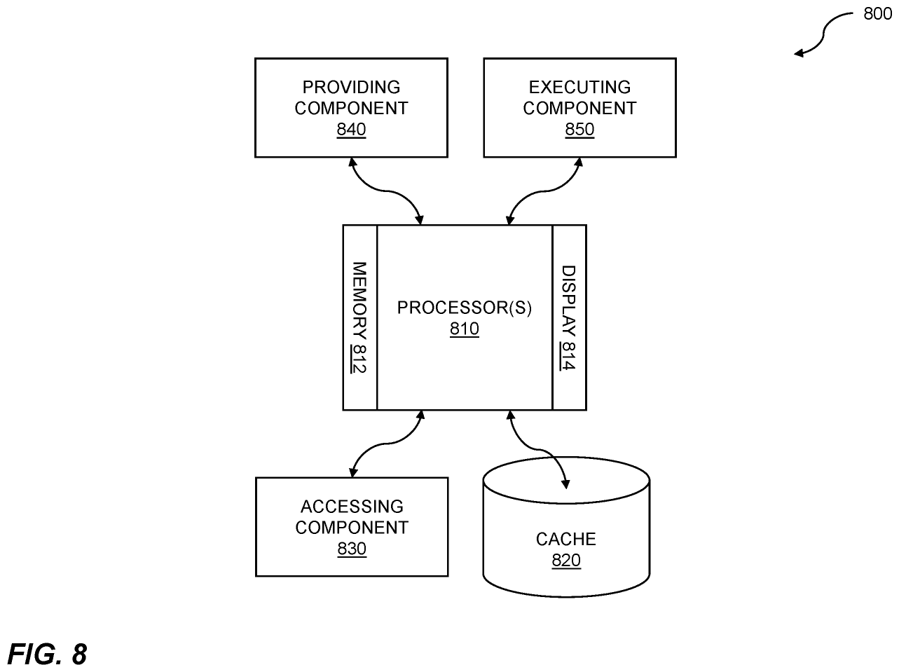

FIG. 8 is a system diagram for task processing. The task processing is performed using a highly parallel processing architecture with a compiler. The system 800 can include one or more processors 810, which are attached to a memory 812 which stores instructions. The system 800 can further include a display 814 coupled to the one or more processors 810 for displaying data; intermediate steps; directions; control words; control words implementing Very Long Instruction Word (VLIW) functionality; topologies including systolic, vector, cyclic, spatial, streaming, or VLIW topologies; and so on. In embodiments, one or more processors 810 are coupled to the memory 812, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; provide a set of directions to the 2D array of compute elements, through a control word generated by the compiler, for compute element operation and memory access precedence, wherein the set of directions enables the 2D array of compute elements to properly sequence compute element results; and execute a compiled task on the array of compute elements, based on the set of directions. In embodiments, the compute element results are generated in parallel in the array of compute elements. The compute element results can be dependent on other compute element results or can be independent of other compute element results. In other embodiments, the compute element results are ordered independently from control word arrival at each compute element within the array of compute elements, as discussed below. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 800 can include a cache 820. The cache 820 can be used to store data, directions, control words, intermediate results, microcode, and so on. The cache can comprise a small, local, easily accessible memory available to one or more compute elements. Embodiments include storing relevant portions of a direction or a control word within the cache associated with the array of compute elements. The cache can be accessible to one or more compute elements. The cache, if present, can include a dual read, single write (2R1W) cache. That is, the 2R1W cache can enable two read operations and one write operation contemporaneously without the read and write operations interfering with one another. The system 800 can include an accessing component 830. The accessing component 830 can include control logic and functions for accessing a two-dimensional (2D) array of compute elements, wherein each compute element within the array of compute elements is known to a compiler and is coupled to its neighboring compute elements within the array of compute elements. A compute element can include one or more processors, processor cores, processor macros, and so on. Each compute element can include an amount of local storage. The local storage may be accessible to one or more compute elements. Each compute element can communicate with neighbors, where the neighbors can include nearest neighbors or more remote “neighbors”. Communication between and among compute elements can be accomplished using a bus such as an industry standard bus, a ringbus, a network such as a wired or wireless computer network, etc. In embodiments, the ringbus is implemented as a distributed multiplexor (MUX). Discussed below, the set of directions can control code conditionality for the array of compute elements. Code conditionality can include a branch point, a decision point, a condition, and so on. In embodiments, the conditionality can determine code jumps. A code jump can change code execution from sequential execution of instructions to execution of a different set of instructions. The conditionality can be established by a control unit. In a usage example, a 2R1W cache can support simultaneous fetch of potential branch paths for the compiled task. Since the branch path taken by a direction or control word containing a branch can be data dependent and is therefore not known a priori, then control words associated with more than one branch path can be fetched prior to (prefetch) execution of the branch control word. As discussed elsewhere, an initial part of the two or more branch paths can be instantiated in a succession of control words. When the correct branch path is determined, the computations associated with the untaken branch can be flushed and/or ignored.

The system 800 can include a providing component 840. The providing component 840 can include control and functions for providing a set of directions to the hardware, through a control word generated by the compiler, for compute element operation and memory access precedence, wherein the set of directions enables the hardware to properly sequence compute element results. The control of the array of compute elements using directions can include configuring the array to perform various compute operations. The compute operations can enable audio or video processing, artificial intelligence processing, deep learning, and the like. The directions can be based on microcode control words, where the microcode control words can include opcode fields, data fields, compute array configuration fields, etc. The compiler that generates the directions can include a general-purpose compiler, a parallelizing compiler, a compiler optimized for the array of compute elements, a compiler specialized to perform one or more processing tasks, and so on. The providing directions can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A set of directions can enable machine learning functionality for the neural network topology.

The system 800 can include an executing component 850. The executing component 850 can include control logic and functions for executing a compiled task on the array of compute elements, based on the set of directions. The set of directions can be provided to a control unit where the control unit can control the operations of the compute elements within the array of compute elements. Operation of the compute elements can include configuring the compute elements, providing data to the compute elements, routing and ordering results from the compute elements, and so on. In embodiments, the same control word can be executed on a given cycle across the array of compute elements. The executing can include decompressing the control words. The control words can be decompressed on a per compute element basis, where each control word can be comprised of a plurality of compute element control groups or bunches. One or more control words can be stored in a compressed format within a memory such as a cache. The compression of the control words can reduce storage requirements, complexity of decoding components, and so on. In embodiments, the control unit can operate on decompressed control words. A substantially similar decompression technique can be used to decompress control words for each compute element, or more than one decompression technique can be used. The compression of the control words can be based on compute cycles associated with the array of compute elements. In embodiments, the decompressing can occur cycle-by-cycle out of the cache. The decompressing of control words for one or more compute elements can occur cycle-by-cycle. In other embodiments, decompressing of a single control word can occur over multiple cycles.

The compiled task, which can be one of many tasks associated with a processing job, can be executed on one or more compute elements within the array of compute elements. In embodiments, the executing of the compiled task can be distributed across compute elements in order to parallelize the execution. The executing the compiled task can include executing the tasks for processing multiple datasets (e.g., single instruction multiple data, or SIMD execution). Embodiments can include providing simultaneous execution of two or more potential compiled task outcomes. Recall that the set of directions can control code conditionality for the array of compute elements. In embodiments, the two or more potential compiled task outcomes comprise a computation result or a flow control. The code conditionality, which can be based on computing a condition such as a value, a Boolean equation, and so on, can cause execution of one of two or more sequences of instructions, based on the condition. In embodiments, the two or more potential compiled outcomes can be controlled by a same control word. In other embodiments, the conditionality can determine code jumps. The two or more potential compiled task outcomes can be based on one or more branch paths, data, etc. The executing can be based on one or more directions or control words. Since the potential compiled task outcomes are not known a priori to the evaluation of the condition, the set of directions can enable simultaneous execution of two or more potential compiled task outcomes. When the condition is evaluated, then execution of the set of directions that is associated with the condition can continue, while the set of directions not associated with the condition (e.g., the path not taken) can be halted, flushed, and so on. In embodiments, the same direction or control word can be executed on a given cycle across the array of compute elements. The executing tasks can be performed by compute elements located throughout the array of compute elements. In embodiments, the two or more potential compiled outcomes can be executed on spatially separate compute elements within the array of compute elements. Using spatially separate compute elements can enable reduced storage, bus, and network contention; reduced power dissipation by the compute elements; etc. Whatever the basis for the conditionality, the conditionality can be established by a control unit.

The system 800 can include a computer program product embodied in a non-transitory computer readable medium for task processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; providing a set of directions to the 2D array of compute elements, through a control word generated by the compiler, for compute element operation and memory access precedence, wherein the set of directions enables the 2D array of compute elements to properly sequence compute element results; and executing a compiled task on the array of compute elements, based on the set of directions.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScriptT™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for task processing comprising:
accessing a two-dimensional (2D) array of compute elements, wherein each compute element within the array of compute elements is known to a compiler and is coupled to its neighboring compute elements within the array of compute elements;
providing a set of directions to the 2D array of compute elements, through a control word generated by the compiler, for compute element operation and memory access precedence, wherein the set of directions enables the 2D array of compute elements to properly sequence compute element results; and
executing a compiled task on the array of compute elements, based on the set of directions.

2. The method of claim 1 wherein the compute element results are generated in parallel in the array of compute elements.

3. The method of claim 1 wherein the compute element results are ordered independently from control word arrival at each compute element within the array of compute elements.

4. The method of claim 1 wherein the set of directions controls data movement for the array of compute elements.

5. The method of claim 4 wherein the data movement includes loads and stores with a memory array.

6. The method of claim 4 wherein the data movement includes intra-array data movement.

7. The method of claim 1 wherein the memory access precedence enables ordering of memory data.

8. The method of claim 7 wherein the ordering of memory data enables compute element result sequencing.

9. The method of claim 1 wherein the set of directions controls the array of compute elements on a cycle-by-cycle basis.

10. The method of claim 9 wherein the cycle-by-cycle basis is enabled by a stream of wide, variable length, microcode control words generated by the compiler.

11. The method of claim 9 wherein the cycle-by-cycle basis comprises an architectural cycle.

12. The method of claim 9 wherein the compiler provides, via the control word, valid bits for each column of the array of compute elements, on the cycle-by-cycle basis.

13. The method of claim 12 wherein the valid bits indicate a valid memory load access is emerging from the array.

14. The method of claim 9 wherein the compiler provides, via the control word, operand size information for each column of the array of compute elements.

15. (canceled)

16. The method of claim 1 wherein the set of directions controls code conditionality for the array of compute elements.

17. The method of claim 16 wherein the conditionality determines code jumps.

18. The method of claim 16 wherein the conditionality is established by a control unit.

19. (canceled)

20. The method of claim 1 wherein the set of directions enables simultaneous execution of two or more potential compiled task outcomes.

21. (canceled)

22. The method of claim 20 wherein the two or more potential compiled task outcomes are controlled by a same control word.

23. The method of claim 22 wherein the same control word is executed on a given cycle across the array of compute elements.

24. The method of claim 23 wherein the two or more potential compiled task outcomes are executed on spatially separate compute elements within the array of compute elements.

25-26. (canceled)

27. The method of claim 1 wherein the set of directions includes a spatial allocation of subtasks on one or more compute elements within the array of compute elements.

28. The method of claim 1 wherein the set of directions includes scheduling computation in the array of compute elements.

29. The method of claim 28 wherein the computation includes compute element placement, results routing, and computation wavefront propagation within the array of compute elements.

30. The method of claim 1 wherein the set of directions enables multiple programming loop instances circulating within the array of compute elements.

31-34. (canceled)

35. A computer program product embodied in a non-transitory computer readable medium for task processing, the computer program product comprising code which causes one or more processors to perform operations of:
accessing a two-dimensional (2D) array of compute elements, wherein each compute element within the array of compute elements is known to a compiler and is coupled to its neighboring compute elements within the array of compute elements;
providing a set of directions to the 2D array of compute elements, through a control word generated by the compiler, for compute element operation and memory access precedence, wherein the set of directions enables the 2D array of compute elements to properly sequence compute element results; and
executing a compiled task on the array of compute elements, based on the set of directions.

36. A computer system for task processing comprising:
a memory which stores instructions;
one or more processors coupled to the memory, wherein the one or more processors, when executing the instructions which are stored, are configured to:
access a two-dimensional (2D) array of compute elements, wherein each compute element within the array of compute elements is known to a compiler and is coupled to its neighboring compute elements within the array of compute elements;
provide a set of directions to the 2D array of compute elements, through a control word generated by the compiler, for compute element operation and memory access precedence, wherein the set of directions enables the 2D array of compute elements to properly sequence compute element results; and
execute a compiled task on the array of compute elements, based on the set of directions.
